(19) United States
(12) Patent Application Publication
(10) Pub. No.: US 2011/0021729 A1
(43) Pub. Date: Jan. 27, 2011

(54) Methods of Purifying Poly(Styrene-co-Maleic Anhydride/Acid)

(76) Inventors: Eyal S. Ron, Lexington, MA (US); Yishai Zohar, Boston, MA (US); Barry J. Hand, Acton, MA (US); Mircea Dan Bucevschi, Rehovot (IL); Monica Colt, Rehovot (IL)

Correspondence Address: ELMORE PATENT LAW GROUP, PC, 515 Groton Road, Unit 1R, Westford, MA, 01886, US

(21) Appl. No.: 12/727,371

(22) Filed: Mar. 19, 2010

Related U.S. Application Data
(63) Continuation of application No. PCT/US2008/077269, filed on Sep. 22, 2008.
(60) Provisional application No. 60/974,270, filed on Sep. 21, 2007.
(60) Provisional application No. 60/978,094, filed on Oct. 5, 2007.
(60) Provisional application No. 60/992,516, filed on Dec. 5, 2007.

(51) Int. Cl. C08F 222/08; C08F 222/02; C08F 6/12

(52) U.S. Cl. 526/272; 526/318.25

(57) ABSTRACT

The present invention relates in part to poly(styrene-co-maleic anhydride/acid) copolymers having high purity, for example, having low amounts of maleic acid, maleic anhydride, and/or styrene. The present invention also relates in parts to methods of purifying poly(styrene-co-maleic anhydride/acid) copolymers to remove the residual monomers and low molecular weight fragments.

### RELATED APPLICATIONS

This application is a continuation of PCT Application No. PCT/US08/077,269, filed Sep. 22, 2008, which claims the benefit of priority of U.S. Provisional Application No. 60/974,270, filed on Sep. 21, 2007, U.S. Provisional Application No. 60/978,094, filed on Oct. 5, 2007, and U.S. Provisional Application No. 60/992,516, filed on Dec. 5, 2007, all of which are hereby incorporated by reference in their entirety.

### FIELD OF THE INVENTION

The invention relates to, in part, poly(styrene-co-maleic anhydride/acid) copolymers of exceptionally high purity. The invention also relates to methods of purifying poly(styrene-co-maleic anhydride/acid) copolymers and methods of synthesizing such polymers using bulk polymerization methods followed by purification, which yield poly(styrene-co-maleic anhydride/acid) copolymers that have very low residual content of monomers (styrene, maleic anhydride and maleic acid).

### BACKGROUND OF THE INVENTION

Poly(styrene-co-maleic anhydride) is used in numerous applications but its use as biocompatible materials is hindered by its low purity and harmful residual contaminates.

Poly(styrene-co-maleic anhydride) has no teratogenic, and no acute or chronic toxic effects when administered or used through non-oral routes (M. M. Muratov, et al., Gig. Sanit, 9, 54-57, 1975 and C. L. Winek and J. J. Burgun, Clinical Toxicology, 10, 255-260, 1977). Poly(styrene-co-maleic anhydride) is used as an efficient, reversible male contraceptive which is injected into the vas deferens (S. K. Guha, et al., Contraception 56, 245-250, 1997 and S. K. Guha et al, Contraception, 58, 165-174, 1998). The safety of long-term vas occlusion with poly(styrene-co-maleic anhydride) has also been assessed on accessory reproductive organs in langur monkeys (Manivannan B. et al., Asian J. Androl., 7, 195-204, 2000).

Sethi, N. et al. demonstrated the biocompatibility of poly(styrene-co-maleic anhydride) commercial products, but a multistep, complex purification procedure was required before utilization (Sethi, N. et al. Contraception, 39, 217-226, 1989). The same conclusion was reported by Lohiya, N. K et al. (Lohiya, N. K. et al. Int. J. Androl., 23, 36-42, 2000).

Wagner J. G. et al in U.S. Pat. No. 2,897,121 and Chen, Y. R. et al. present the utilization of poly(styrene-co-maleic anhydride) copolymers as additives for a pharmaceutical carrier for oral administration (Chen, Y. R. et al., Colloids and Surfaces A: Physicochem. Eng. Aspects, 242, 17-20, 2004). Although the authors assert that the polymers can be used as a biocompatible material, supporting data, such as purity, is not presented.

Patel, H. A. et al. disclose the synthesis, release study, and antimicrobial properties of acriflavine bound to poly(styrene-co-maleic anhydride) (Patel, H. A. et al. Die Angewandte Makromolekulare Chemie, 263, 25-30, 1998). Patel, H. A. et al. report similar findings for Poly(styrene-co-maleic anhydride) bound ampicillin (Patel, H. A. et al. Die Angewandte Makromolekulare Chemie, 271, 24-27, 1999). In both cases, advanced purification of the poly(styrene-co-maleic anhydride) copolymer was necessary to make the composition acceptable as biocompatible. Ottenbrite, R. M., discloses the use of poly(styrene-co-maleic anhydride) copolymers as anti-tumor effectors (Ottenbrite, R. M. J., Macromol. Sci.-Chem, A22, 819-832, 1985). Spiridon, D demonstrated the biocompatibility of the poly(styrene-co-maleic anhydride) copolymers but only after rigorous purification steps (Spiridon D., Polymer International, 43, 175-181, 1997).

U.S. Pat. No. 3,980,663 and U.S. Pat. No. 4,381,784 disclose use of poly(styrene-co-maleic anhydride) copolymers as water absorbing materials for hygienic care. U.S. Pat. No. 3,939,108 and U.S. Pat. No. 6,590,019 disclose poly(styrene-co-maleic anhydride) copolymers as an adhesive useful for bottle labeling. U.S. Pat. No. 5,080,888 discloses poly(styrene-co-maleic anhydride) copolymers in cosmetics. U.S. Pat. No. 4,980,403, U.S. Pat. No. 5,104,957, U.S. Pat. No. 5,480,427; and U.S. Pat. No. 6,127,451 disclose use of poly(styrene-co-maleic anhydride) copolymers as biomaterials. U.S. Pat. No. 4,153,682, U.S. Pat. No. 6,500,447 and U.S. Pat. No. 6,531,160 disclose use of poly(styrene-co-maleic anhydride) copolymers in pharmaceutical products as drug delivery systems.

In order to use poly(styrene-co-maleic anhydride) copolymers as biocompatible materials, the polymer's chemical purity should be as high as possible, while its harmful contaminants content should be as low as possible. Contamination of poly(styrene-co-maleic anhydride) copolymers has two significant causes derived from the polymerization processes used: 1) non-reacted monomers and 2) auxiliaries of polymerization reaction, such as: organic solvents, initiators . . . etc. Additionally, lower molecular weight polymers can contaminate the polymer, such as polymers with molecular weights lower than 70 KD or less than 35 KD.

For instance, the FDA approved poly(styrene-co-maleic anhydride) copolymers as indirect food additives for use as articles or components of articles that contact food items. But, the FDA has specified that poly(styrene-co-maleic anhydride) copolymers have a minimum average molecular mass of 70,000 and contain not more that 15 weight percent maleic anhydride, 0.3 weight percent residual styrene monomer, 0.1 weight percent residual maleic anhydride monomer, 0.006 weight percent maximum extractible fractions in distillated water at reflux temperature for 1 hr, and 0.02 weight percent maximum extractible fractions in n-heptane at 73° F. for 2 hrs (Code of Federal Regulations, Sec. 177.1820 “Styrene-maleic anhydride copolymers”, Title 21, Volume 3, pgs. 304-305, revised as of Apr. 1, 2000).

Poly(styrene-co-maleic anhydride) copolymers are prepared mainly by solvent based methods, but these methods result in residual solvents that need to be removed in addition to unreacted monomers and initiators. See U.S. Pat. No. 2,286,062; U.S. Pat. No. 2,378,629; U.S. Pat. No. 2,866,775; U.S. Pat. No. 3,157,595; U.S. Pat. Nos. 3,989,586; 4,105,649; and U.S. Pat. No. 4,126,549. The additional purification steps required represent an important economic restriction to using poly(styrene-co-maleic anhydride) copolymers in bio-applications compared to other types of polymers.

Bulk polymerization is less contaminating than solution polymerization because there are no organic solvents. See Voss, A. et al. in U.S. Pat. No. 2,047,398; Graves, G. D. in U.S. Pat. No. 2,205,882 and Lee Y. C. et al. in U.S. Pat. No. 4,051,311 which disclose maleic anhydride copolymers of styrene, vinyl acetate, and others by bulk polymerization methods, with and without peroxidic initiators. The content of maleic anhydride monomers is less than 55% by weight in the initial mixture of comonomers. Baer, M. in U.S. Pat. No. 2,971,939 presents the synthesis of styrene maleic anhydride copolymers with a content of maleic anhydride less than 12% by weight using bulk polymerization methods. In these disclosures, a mixture of styrene and peroxidic initiator is allowed to homopolymerize until a 3-5% conversion. At this point, maleic anhydride monomer is added at a constant rate to form a maleic anhydride in styrene solution. The poly(styrene-co-maleic anhydride) copolymer is then extracted from the reaction mass with benzene and ultimately separated from the solution by precipitation with methanol.

The disadvantages of these bulk polymerization methods include: a) incomplete conversion of monomers to copolymer due to increased impedance of diffusion of the reactants to reaction centers because of increased reaction mass viscosity; b) purification to remove non-reacted monomer is difficult and realized by dissolution into specific solvents (such as acetone or benzene), followed by precipitation, extraction with alcohols or water, and drying; c) generation of large amounts of reaction heat, risking explosion; d) handling of reaction mass is difficult; and e) purification of solids after precipitation by extraction is neither cost effective nor ecologically friendly.

Cutter, L. A. in U.S. Pat. No. 4,145,375 presents a process for copolymerizing styrene and maleic anhydride which involves a sequence of operations in which maleic anhydride is first gradually mixed with styrene in a mass stage under polymerizing conditions to rapidly form styrene-maleic anhydride polymer. The styrene-rich mixture is then suspended in water and the styrene polymerization completed as in a conventional mass/suspension polymerization system. The suspension step further modifies the polymer by opening the anhydride group to form free carboxylic acid groups on the polymer chain. Following the heating period, the polymerization mixture is cooled, the polymer beads are separated from the water by a solid-bowl centrifuge, and dried in a rotary air drier. The resulting polymers have Mw=100,000-500,000, and the content of residual styrene is between 0.02 and 0.1% by weight. A disadvantage of this process is that the final product is a blend of polystyrene and poly(styrene-co-maleic anhydride), the polystyrene is being a major contaminant, making it unsuitable for bio-applications. Similar issues are raised by front polymerization, which uses excess of styrene (Szalay, J. et al., Macromol. Rapid Commun., 20(6), 315-318, 1999).

Methods of copolymerization of maleic anhydride and other monomers in an aqueous medium have been disclosed. See Bomer B. et al. in U.S. Pat. No. 4,737,549; Saraydin D. et al. in J. Appl. Polym. Sci., 79, 1809-1815, 2001; Caycara, T. et al. in J. Polym. Sci. A: Polym. Chem., 39, 277-283, 2001; Akkas, P. et al. in J. Appl. Polym. Sci., 78, 284-289, 2000; Sen, M. et al. in Polymer 1999, 40, 913-917; Sen, M. et al. in Polymer 1998, 39, 1165-1172; Karadag, E. et al. in J. Appl. Polym. Sci., 66, 733-739, 1997; Saraydin, D. et al. in Biomaterials, 15, 917-920, 1994; and Karadag, E. et al. in Biomaterials, 17, 6770, 1996. Nevertheless, these methods cannot be used for copolymerizing styrene due to the differences in solubility of the two monomers. Additionally, the resulting polymer will have few carboxylic groups, limiting the number of potential bio-applications.

Copolymerization yields are highest (approximately 95%) when using equimolecular monomer feeds, and with processes that achieve good mass transfer of reactants (such as those achieved by polymerization in organic solvent media). Processes that don't use equimolecular monomer feeds induce a high value of conversion only for the monomer which is present in the least amount (Klumperman, B. et al. Polymer, 34, 1032-1037, 1993; Klumperman, B. Macromolecules, 27, 6100-6101, 1994; Klumperman, B. et al. Eur. Polym. J., 30, 955-960, 1994).

Sujoy in U.S. Pat. No. 5,488,075 describes the preparation of poly(styrene-co-maleic anhydride) by subjecting a mixture of styrene and maleic anhydride in ethyl acetate under a nitrogen atmosphere to the step of irradiation at a dose of 0.2 to 0.24 MRad for every 40 g of said mixture (The source of irradiation is cobalt 60 gamma radiation.). The resulting copolymer has a molecular weight between 60,000 and 100,000 Daltons and has styrene to maleic anhydride ratio of 1:1 to 1.2:1. This method of synthesis yields polymers with many uncharacterized contaminants.

One difficult aspect of purifying poly(styrene-co-maleic anhydride) copolymers is removal of unreacted styrene because it is an organic compound liquid which is insoluble in water, but soluble in organic solvents with high boiling points that make it difficult to dry, even in a high vacuum. (Boundy, R. H. “Styrene, its polymers, Copolymers and Derivatives,” Reinhold Publishing Corporation, New York, 860-865, 1952).

Unreacted maleic anhydride can be removed by simple hydrolysis with water to form maleic acid which has a high solubility in water (greater than 4.4×10⁵ ppm (wt) at 25° C.) (Yaws C. L. in “Chemical Properties Handbook” McGraw-Hill Companies, Inc., New York, 1999), allowing its efficient and economical elimination from copolymers. In addition, the rate of hydrolysis of free maleic anhydride is much higher than that of polymerized maleic anhydride in this method (Ratzch, M. et al. J. Macromol. Sci-Chem. A24, 949-965, 1987; Wang, M. et al. J. AppL. Polym. Science, 75, 267-274, 2000).

Maleic anhydride is converted into maleic acid when it is hydrolyzed. The two monomers, maleic acid and maleic anhydride are recognized as separate chemical entities and have each been assigned different CAS Registry Numbers by the Chemical Abstract Services (e.g., 108-31-6 for maleic anhydride and 110-16-7 for maleic acid). In addition, the chemical properties of maleic acid and maleic anhydride differ (e.g., the melting point of maleic anhydride is 53° C. while the melting point of maleic acid is 131° C.). Therefore a polymer that incorporates maleic anhydride will behave differently than a polymer that incorporates maleic acid. For instance, poly(styrene-co-maleic anhydride) which incorporates maleic anhydride, differs from poly(styrene-co-maleic anhydride/acid) which includes maleic acid or a mixture of maleic anhydride and maleic acid.

Elvira, C. et al. discussed the use poly(styrene-co-maleic anhydride/acid) as the backbone for polymer-drug conjugates used as drug delivery systems (Elvira, C. et al., Molecules, 2005, 10, 114-125). Maeda reported that these poly(styrene-co-maleic anhydride/acids) had low molecular weight around 16,000 Daltons (Maeda, H. et al J. of Protein Chem., 1984, 3, 181-193). M. Kovac Filipovic, et al. reported the heterogeneous copolymerization of styrene and maleic anhydride in toluene, (M. Kovac Filipovic, et al. Polimeri, 1989, 10, 157-159) to form poly(styrene-co-maleic anhydride/acid).

The purification of poly(styrene-co-maleic anhydride/acid) using water is challenging. The polymer uptakes water due to hydrogen interactions, between the malic acid moieties and the water, and as a result the polymer swells while the absorbed water retains the impurities and makes the purification particularly difficult. Additionally, the swollen poly(styrene-co-maleic anhydride/acid) is difficult to filter as it clogges the filter and the processing on a large scale is difficult.

In order to overcome the polymers' swelling one could use organic non-solvents to collapse and participate the polymer from the aqueous mediand therefore “liberate” the water from the polymer and allow further purification. As a result organic solvents need to be removed from the purified polymer.

It is desirable to synthesis poly(styrene-co-maleic anhydride/acid) for biomedical applications by removing the low molecular weight byproducts, which include maleic anhydride, maleic acid and styrene monomers and low molecular weight polymers (polymers with molecular weight below 70,000) without using organic solvents. To date, no effective method has been reported. Such a method would ideally also be scalable to an industrial level.

### SUMMARY OF THE INVENTION

In one aspect, the invention relates to a poly(styrene-co-maleic anhydride/acid) copolymer having less than 0.010% by weight unreacted styrene monomer.

In a further embodiment, the poly(styrene-co-maleic anhydride/acid) has levels of unreacted styrene monomer that are below levels of detection limits using analytic methods known to one skilled in the art, for example, with a threshold of detection of 0.061 microgram/mL. For example, the styrene monomer is undetectable using HPLC having a detection limit of 0.002%.

In a further embodiment, the poly(styrene-co-maleic anhydride/acid) has less than 0.2% by weight unreacted maleic anhydride and maleic acid combined.

In another embodiment, the poly(styrene-co-maleic anhydride/acid) has combined levels of unreacted maleic anhydride and acid monomer that are below levels of detection limits using analytic methods known to one skilled in the art, for example, with a threshold of detection of 0.036 microgram/mL. For example, the maleic anhydride and maleic acid monomers cannot be detected using reverse phase HPLC having a detection limit of 0.001%.

In a further embodiment, the ratio of styrene to maleic acid in the poly(styrene-co-maleic anhydride/acid) backbone is substantially 1:1.

In another aspect, the present invention relates to a medicament comprising the poly(styrene-co-maleic anhydride/acid) of the present invention.

In another aspect, the present invention relates to an article of manufacture comprising the poly(styrene-co-maleic anhydride/acid) of the present invention.

In a further embodiment, the article of manufacture is used in the field of medical devices, bioengineering, tissue engineering, pharmaceutical products, body hygiene, cosmetics, biotechnology, food industry, agriculture, or absorbent textiles.

The present invention is also directed to methods of making the aforementioned poly(styrene-co-maleic anhydride/acid) copolymers by purifying a poly(styrene-co-maleic anhydride/acid. The poly(styrene-co-maleic anhydride/acid) can be prepared by any method known in the art for making such polymers. In addition, the purification methods described herein may be used to purify commercial and/or proprietary poly(styrene-co-malic anhydride) (SMA) and poly(styrene-co-maleic acid) (SMAc) polymers (such as, for example, Scripset® which is sold by Hercules). In other words, the methods described herein can be applied to any polymer, including those which are commercially available.

For example, one aspect of the invention relates to methods of purifying poly(styrene-co-maleic anhydride/acid) copolymers, comprising washing the copolymer with acid, Tangential Flow Filtration of the copolymer, or dialysis of the copolymer. These purification methods can remove unreacted styrene, maleic anhydride and maleic acid monomers. In certain embodiments, the methods also can remove lower molecular weight polymers, e.g. polymers with molecular weight of 70 KD or less.

In a further embodiment, the method comprises washing the copolymer by extracting free maleic acid with an aqueous media. In certain embodiments, the aqueous media is water. In certain embodiments, the water is removed by filtration under pressure. In a further embodiment, the residual water is removed from the filtrate-cake by high pressure. In a further embodiment, the extraction is repeated until the content of maleic acid in the polymer is less than 0.0045% by weight. In a further embodiment, the temperature of the washing procedure is lower than 45° C. to prevent a morphology change in the poly(styrene-co-maleic anhydride/acid) as the polymer turns into a gel mass.

In another embodiment of the invention, the washing is done with acidic water.

In another embodiment of the invention, the washing is done with acidic water with pH between 1.5 and 5. In another embodiment of the invention, the washing is repeated with acidified water until the content of maleic acid in the poly(styrene-co-maleic anhydride/acid) is below quantification level. In another embodiment of the invention, the washing is repeated with acidified water followed by purified water to reduce the amount of acid in the poly(styrene-co-maleic anhydride/acid). In another embodiment of the invention, the acidic media could be a solutions of mineral acid such as hydrochloric acid, hydrobromic acid, hydrofluoric acid, hydroiodic acid, nitric acid, sulfuric acid, perchloric acid, fluoroantimonic acid (HFSbF₅), magic acid (FSO₃HSbF₅), carborane superacid (CHB₁₁Cl₁₁), fluorosulphuric acid (FSO₃H), phosphoric acid, or chromic acid; carboxylic acids such as formic acid, acetic acid, trifluoroacetic acid, tartaric acid, citric acid, or ascorbic acid; sulfonic acids such as methanesulfonic acid, trifluoromethane sulfonic acid, or toluenesulfonic acid; and the like, or mixtures thereof.

In another embodiment of the invention, the washing is repeated with water followed by a wash with acidified water followed by washes with water, which may be purified water, to reduce the amount of acid in the poly(styrene-co-maleic anhydride/acid).

In a further embodiment, the water is removed by filtration under pressure. In a further embodiment, a filter-press is used to remove the bound water; filter-press consists of three main components: a circulation/feed pump, filter plates and a pneumatic bladder inside each plate. In a further embodiment, the solids, swollen with liquid, are squeezed against the filter plated by expanding the pneumatic bladder with compressed gas at about 50-250 psi; or at about 50-150 psi. In a further embodiment, the pressure is maintained for a few minutes and the released. The compressed cake could then be partially dried by blowing gas. In a further embodiment, the solids swollen with liquid are squeezed by rollers, centrifugal forces, or other means of pressure.

In a further embodiment, the water is removed by Tangential Flow Filtration.

In a further embodiment, the water is removed by Tangential Flow Filtration with a molecular weight cut off membrane 3-6 times smaller than the MW of molecules to be retained. In a further embodiment, the water is removed by Tangential Flow Filtration with a molecular weight cut off membrane of 15-35 KD. In another embodiment of the invention, the washing is conducted using a Tangential Flow Filtration with a molecular weight cut off above 15 KD.

In certain embodiments, the method of purifying a poly(styrene-co-maleic anhydride/acid) copolymer further comprises the use of Tangential Flow Filtration; and further combining the poly(styrene-co-maleic anhydride/acid) copolymer with alkaline water.

In certain embodiments, the method of purifying a poly(styrene-co-maleic anhydride/acid) copolymer further comprises the use of Tangential Flow Filtration, wherein the pH of the alkaline water is between about 7.5 and about 10.

In certain embodiments, the method of purifying a poly(styrene-co-maleic anhydride/acid) copolymer further comprises the use of Tangential Flow Filtration, wherein the combining of the copolymer and alkaline water is performed prior to the Tangential Flow Filtration.

In certain embodiments, the method of purifying a poly(styrene-co-maleic anhydride/acid) copolymer further comprises the use of Tangential Flow Filtration, wherein the poly(styrene-co-maleic anhydride/acid) copolymer and alkaline water form a homogenous mixture.

In certain embodiments, the method of purifying a poly(styrene-co-maleic anhydride/acid) copolymer further comprises the use of Tangential Flow Filtration, wherein the Tangential Flow Filtration has a molecular weight cutoff of about 70 KD or less.

In certain embodiments, the method of purifying a poly(styrene-co-maleic anhydride/acid) copolymer further comprises the use of Tangential Flow Filtration, wherein the Tangential Flow Filtration is continued until the content of the maleic acid in the supernatant is less than 0.1% by weight.

In certain embodiments, the method of purifying a poly(styrene-co-maleic anhydride/acid) copolymer further comprises the use of Tangential Flow Filtration, wherein the maleic acid in the supernatant is less than 0.01% or less.

In certain embodiments, the method of purifying a poly(styrene-co-maleic anhydride/acid) copolymer further comprises the use of Tangential Flow Filtration, wherein the temperature during the Tangential Flow Filtration is between 2° C. and 45° C.

In certain embodiments, the method of purifying a poly(styrene-co-maleic anhydride/acid) copolymer further comprises the use of Tangential Flow Filtration, further comprising maintaining the pH above 3.

In certain embodiments, the method of purifying a poly(styrene-co-maleic anhydride/acid) copolymer further comprises the use of Tangential Flow Filtration, further comprising precipitating the poly(styrene-co-maleic anhydride/acid) copolymer from the aqueous alkaline water by acidifying the mixture to a pH less than about 2.

In certain embodiments, the method of purifying a poly(styrene-co-maleic anhydride/acid) copolymer further comprises the use of Tangential Flow Filtration, wherein the mixture is acidified by adding an acid selected from the group consisting of hydrochloric acid, hydrobromic acid, hydrofluoric acid, hydroiodic acid, nitric acid, sulfuric acid, perchloric acid, fluoroantimonic acid (HFSbF₅), magic acid (FSO₃HSbF₅), carborane superacid (CHB₁₁Cl₁₁)), fluorosulphuric acid (FSO₃H), phosphoric acid, chromic acid, formic acid, acetic acid, trifluoroacetic acid, tartaric acid, citric acid, ascorbic acid; methanesulfonic acid, trifluoromethane sulfonic acid, toluenesulfonic acid, or mixtures thereof.

In a further embodiment, the first two washes are done by filtration under pressure followed by Tangential Flow Filtration.

In another embodiment of the invention, the washing is conducted by dissolving the crude poly(styrene-co-maleic anhydride/acid) in basic water and using a Tangential Flow Filtration with a molecular weight cut off above 15 KD.

In a further embodiment of the invention, the poly(styrene-co-maleic anhydride/acid) previously subjected to Tangential Flow Filtration is precipitated from the basic aqueous media by acidifying the solution to pH<2.

In other embodiments, the copolymer is further purified via dialysis of the poly(styrene-co-maleic anhydride/acid) copolymer.

In certain embodiments, the copolymer is further purified via dialysis of the poly(styrene-co-maleic anhydride/acid) copolymer wherein the poly(styrene-co-maleic anhydride/acid) copolymer is in an aqueous solution, and the solution is maintained at a pH of less than 3.

In certain embodiments, the copolymer is further purified via dialysis of the poly(styrene-co-maleic anhydride/acid) copolymer wherein the copolymer is in an aqueous solution, and the solution is maintained at a pH of greater than 6.

In certain embodiments, the copolymer is further purified via dialysis of the poly(styrene-co-maleic anhydride/acid) copolymer wherein the dialysis occurs for a period of about 1-24 hours.

In certain embodiments, the copolymer is further purified via dialysis of the poly(styrene-co-maleic anhydride/acid) copolymer; and the poly(styrene-co-maleic anhydride/acid) copolymer is precipitated by acidifying the aqueous solution to a pH of less than 2.

In certain embodiments, the copolymer is further purified via dialysis of the poly(styrene-co-maleic anhydride/acid) copolymer; the poly(styrene-co-maleic anhydride/acid) copolymer is precipitated by acidifying the aqueous solution; and the solution is acidified by addition of an acid selected from the group consisting of hydrochloric acid, hydrobromic acid, hydrofluoric acid, hydroiodic acid, nitric acid, sulfuric acid, perchloric acid, fluoroantimonic acid (HFSbF₅), magic acid (FSO₃HSbF₅), carborane superacid (CHB₁₁Cl₁₁)), fluorosulphuric acid (FSO₃H), phosphoric acid, chromic acid, formic acid, acetic acid, trifluoroacetic acid, tartaric acid, citric acid, ascorbic acid; methanesulfonic acid, trifluoromethane sulfonic acid, toluenesulfonic acid, or mixtures thereof.

In a further embodiment, the dialysis is continued while maintaining the system's pH below 3. In a further embodiment, the dialysis is continued while maintaining the system's pH above 6.

In a further embodiment, the free maleic acid is removed by dialysis until the content of maleic acid in the supernatant is less than 0.01% by weight.

In a further embodiment, the poly(styrene-co-maleic anhydride/acid) is purified by extraction with a super critical fluid. In certain embodiments, the copolymer is further purified via use of supercritical fluid extraction wherein the supercritical fluid is supercritical carbon dioxide. In certain embodiments, the copolymer is further purified via use of supercritical fluid extraction wherein the purifying does not comprise the use of organic solvents.

In a further embodiment, the wet poly(styrene-co-maleic anhydride/acid) is dried in a filter dryer, forced air oven, fluidizer bed, via spray-drying and/or via freeze-drying.

### BRIEF DESCRIPTION OF THE FIGURES

FIG. 1 is a typical HPLC chromatogram of residual styrene from extraction with benzene in a copolymer that is not purified according to the methods of the present invention.

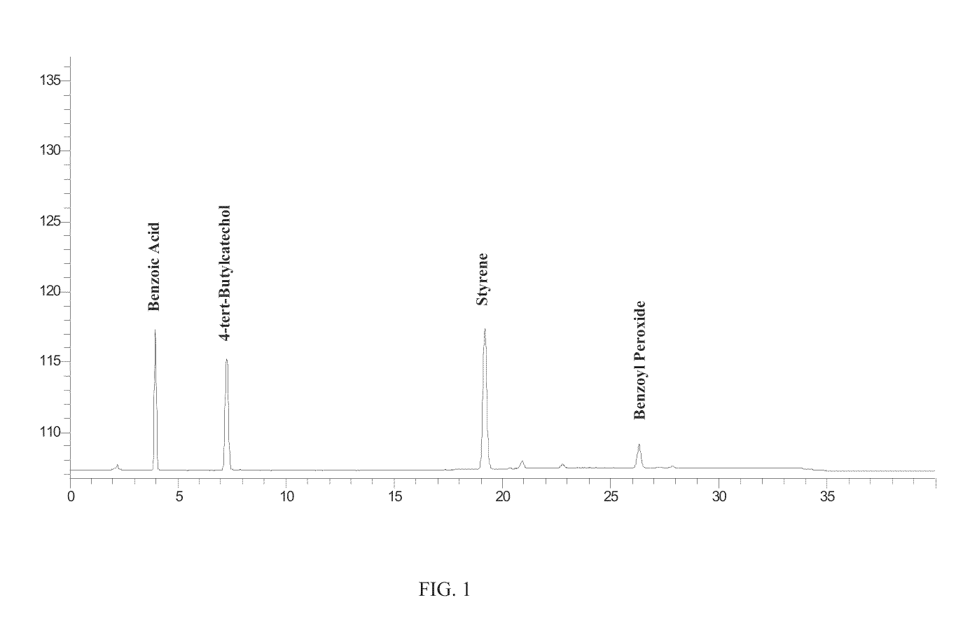

FIG. 2 is a typical RP-HPLC chromatogram of maleic anhydride/acid residues in a copolymer that is not purified according to the methods of the present invention.

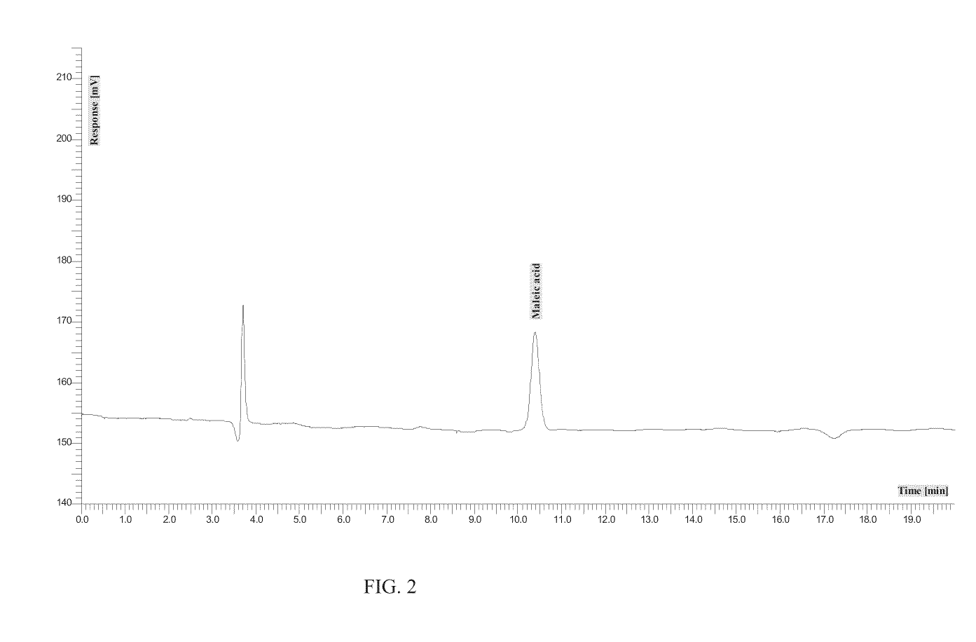

FIG. 3 is a sample FTIR Spectrum. A band between 1710 cm-1 and 1720 cm-1 corresponds to the carbonyl absorption in the maleic acid residues in the backbone. The band centered at approximately 1777 cm-1 corresponds to the carbonyl absorption of anhydride groups in the backbone. The region between 2500-3800 cm-1 contains bands corresponding to the oxygen-hydrogen stretching vibrations of carboxyl groups.

FIG. 4 is a ¹H NMR Spectra of poly(styrene-co-maleic anhydride/acid). The ratio of the aromatic peak (˜7 PPM, relates to Styrene) to the aliphatic peak (˜2 PPM relates to maleic acid) is around 1:1, indicating that the resulting polymers have a substantial equal amounts of styrene and maleic acid building units.

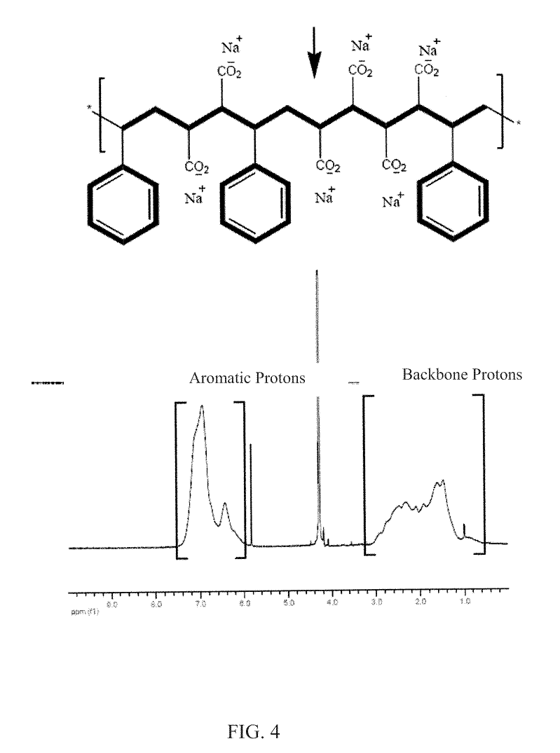

FIG. 5 depicts the increased cake solid content of a filter press vs. traditional filtration (from Avery Filter Company, Inc. Technical information).

### DETAILED DESCRIPTION OF THE INVENTION

### Definitions

The term “biocompatibility” as used herein refers to biochemical characteristics which a material possess that makes it acceptable to living organisms (human, animals and plants), as an integral part of them, without have spontaneous or in time the manifestation of some repulsive or toxic phenomena under the form of inflammation, infections and others (Black J., “Biological Performance of Materials: Fundamentals of Biocompatibility”, 2d ed. M. Dekker, N.Y., 1992). This interpretation is given both to pure materials (100% purity, other substances not detected) and those that have a purity less than 100% (because they contain contaminants).

The standards that have guided biocompatibility testing are: 1) Tripartite Guidance; 2) the International Organization for Standardization (ISO) 10993 standards (which are known as the Biological Evaluation of Medical Devices and remain under development internationally) and 3) the FDA Blue Book Memoranda.

The term “poly(styrene-co-maleic anhydride/acid)” as used herein refers to a copolymer comprising styrene units and maleic anhydride units, wherein at least a portion of the maleic anhydride units are hydrolyzed to the corresponding maleic acid units. The term poly(styrene-co-maleic anhydride/acid), however, is not limited to the manner in which the copolymer is made. For example, the poly(styrene-co-maleic anhydride/acid) can be formed by polymerization of styrene and maleic anhydride to form a poly(styrene-co-maleic anhydride), followed by hydrolysis of at least a portion of the anhydride units to maleic acid units. Poly(styrene-co-maleic anhydride/acid) also may be formed, for example, by polymerization of styrene monomers and a mixture of maleic anhydride and maleic acid monomers. Thus, the term poly(styrene-co-maleic anhydride/acid) refers to the final structure of the copolymer, and not the method by which it was made.

Poly(Styrene-Co-Maleic Anhydride/Acid) with Low Residual Monomers

One aspect of the invention relates to poly(styrene-co-maleic anhydride/acid) polymers have low amounts of monomers, such as styrene, maleic acid, maleic anhydride, or a combination thereof.

In one aspect, the invention relates to a poly(styrene-co-maleic anhydride/acid) copolymer having less than 0.010% by weight styrene monomer.

In a further embodiment, the poly(styrene-co-maleic anhydride/acid) has levels of styrene monomer that are below levels of detection limits using analytic methods known to one skilled in the art, for example, with a threshold of detection of 0.061 microgram/mL. For example, the styrene monomer is undetectable using HPLC. In some embodiments, the HPLC has a detection limit of 0.002% or less for styrene.

In a further embodiment, the poly(styrene-co-maleic anhydride/acid) has less than 0.2% by weight maleic anhydride and maleic acid combined. In another embodiment, the poly(styrene-co-maleic anhydride/acid) has less than 0.001% by weight maleic anhydride and maleic acid combined.

In another embodiment, the poly(styrene-co-maleic anhydride/acid) has combined levels of unreacted maleic anhydride and acid monomer that are below levels of detection limits using analytic methods known to one skilled in the art, for example, with a threshold of detection of 0.036 microgram/mL. For example, the maleic anhydride and maleic acid monomers cannot be detected using reverse phase HPLC. In some embodiments, the HPLC has a detection limit of 0.001% or less for maleic acid and maleic anhydride combined.

In a further embodiment, the ratio of styrene to maleic acid in the poly(styrene-co-maleic anhydride/acid) backbone is substantially 1:1.

In another aspect, the present invention relates to a medicament comprising the poly(styrene-co-maleic anhydride/acid) of the present invention.

In another aspect, the present invention relates to an article of manufacture comprising the poly(styrene-co-maleic anhydride/acid) of the present invention.

In a further embodiment, the article of manufacture is used in the field of medical devices, bioengineering, tissue engineering, pharmaceutical products, body hygiene, cosmetics, biotechnology, food industry, agriculture, or absorbent textiles.

### Methods of Purifying Poly(Styrene-Co-Maleic Anhydride/Acid)

The present invention is also directed to methods of making the aforementioned poly(styrene-co-maleic anhydride/acid) copolymers by purifying a poly(styrene-co-maleic anhydride/acid. The poly(styrene-co-maleic anhydride/acid) can be prepared by any method known in the art for making such polymers. For example, in one embodiment, the poly(styrene-co-maleic anhydride/acid) is prepared according to the methods described in WO 2007/115165, which is hereby incorporated by reference in its entirety.

In certain embodiments, the method of purifying a poly(styrene-co-maleic anhydride/acid) copolymer, comprises removing from the copolymer unreacted styrene monomers, unreacted maleic anhydride monomers, unreacted maleic acid monomers, low molecular weight copolymers, or a combination thereof. In certain embodiments, the purification comprises an acid wash, Tangential Flow Filtration, dialysis, super critical fluid extraction, or a combination thereof. In certain embodiments, the purification comprises an acid wash.

In certain embodiments, the purification comprises an acid wash; wherein the acidic solution comprises an acid selected from the group consisting of hydrochloric acid, hydrobromic acid, hydrofluoric acid, hydroiodic acid, nitric acid, sulfuric acid, perchloric acid, fluoroantimonic acid (HFSbF₅), magic acid (FSO₃HSbF₅), carborane superacid (CHB₁₁Cl₁₁), fluorosulphuric acid (FSO₃H), phosphoric acid, chromic acid, formic acid, acetic acid, trifluoroacetic acid, tartaric acid, citric acid, ascorbic acid; methanesulfonic acid, trifluoromethane sulfonic acid, toluenesulfonic acid, or mixtures thereof. In certain embodiments, the purification comprises an acid wash, wherein the acidic solution has an acid concentration of between 0.0005-0.01 M. In certain embodiments, the purification comprises an acid wash, wherein the acid is hydrochloric acid in a concentration of about 0.001 to about 0.1M.

In certain embodiment of the invention, the washing (i.e. acid wash) is done with acidic water with pH between 1.5 and 5; or between 1.5 and 4; at of about 3. In another embodiment of the invention, the washing is repeated with acidified water until the content of maleic acid in the poly(styrene-co-maleic anhydride/acid) is below quantification level. In another embodiment of the invention, the washing is repeated with water followed by a wash with acidified water followed by at least one wash with water to reduce the amount of acid in the poly(styrene-co-maleic anhydride/acid). In some embodiments, several washes are used to remove the acid. The water used for washing may be purified water.

In some embodiments, the washing provides a copolymer having less than 0.002% unreacted styrene and less than 0.001% unreacted maleic anhydride and maleic acid, combined.

In some embodiments, the washing is done at a temperature <45° C. In some embodiments, the washing is done at a temperature <10° C.

In certain embodiments, the purification comprises an acid wash wherein the acid concentration is sufficient to prevent swelling of the poly(styrene-co-maleic anhydride/acid) copolymer.

In certain embodiments, the purification comprises an acid wash wherein the aqueous acidic solution is removed by filtration. In certain embodiments, the purification comprises an acid wash wherein the aqueous acidic solution is removed by filtration; further comprising washing the poly(styrene-co-maleic anhydride/acid) copolymer with water.

In certain embodiments, the purification comprises an acid wash wherein the aqueous acidic solution is removed by filtration, wherein the temperature during the washings is less than 45° C. In certain embodiments, the purification comprises an acid wash wherein the aqueous acidic solution is removed by filtration, wherein the temperature is between 2° C. and 45° C. In certain embodiments, the purification comprises an acid wash wherein the aqueous acidic solution is removed by filtration, wherein the temperature is in a range of about 5° C. to about 40° C. In certain embodiments, the purification comprises an acid wash wherein the aqueous acidic solution is removed by filtration, wherein the temperature is in a range of about 15° C. to about 35° C.

In certain embodiments, the purification comprises an acid wash wherein the aqueous acidic solution is removed by filtration, wherein the washing is repeated more than once.

In certain embodiments, the purification comprises an acid wash wherein the aqueous acidic solution is removed by filtration, wherein each washing cycle is less than 2 hours.

In certain embodiments, the method of purifying a poly(styrene-co-maleic anhydride/acid) copolymer further comprises filtering the poly(styrene-co-maleic anhydride/acid) copolymer.

In a further embodiment, the water is removed by filtration under pressure.

In a further embodiment, a filter-press is used to remove the bound water; filter-press consists of three main components: a circulation/feed pump, filter plates, and a pneumatic bladder inside each plate. Plates are covered with filter cloths of a prescribed porosity. The poly(styrene-co maleic anhydride/acid) is fed to the cavity between the plates by the circulating pump. Liquid passes through the filter plates, while the solids are retained in the filter-press cavity. After all the liquid has been pumped through, the solids, swollen with liquid and squeezed against the filter plated by expanding the pneumatic bladder with compressed gas at, for example, 100 psi. In certain embodiments, the pressure of the filter press is about 50 to about 150 psi. Pressure is maintained for a few minutes and the released. The compressed cake can then be partially dried by blowing gas through the feed lines. After compression and possibly air drying the press is opened and material will fall into a receiving pan below or is hand scooped out of the cavities.

In other embodiments, undesirable side products of the copolymerization reaction may be removed by Tangential Flow Filtration. For example, low molecular side products can be removed use Tangential Flow Filtration. In some embodiments, the molecular weight cutoff of the Tangential Flow Filtration is about 70 KD or less.

In certain embodiments, the method of purifying a poly(styrene-co-maleic anhydride/acid) copolymer further comprises the use of Tangential Flow Filtration; and further combining the poly(styrene-co-maleic anhydride/acid) copolymer with alkaline water.

In certain embodiments, the method of purifying a poly(styrene-co-maleic anhydride/acid) copolymer further comprises the use of Tangential Flow Filtration, wherein the pH of the alkaline water is between about 7.5 and about 10.

In certain embodiments, the method of purifying a poly(styrene-co-maleic anhydride/acid) copolymer further comprises the use of Tangential Flow Filtration, wherein the combining of the copolymer and alkaline water is performed prior to the Tangential Flow Filtration.

In certain embodiments, the method of purifying a poly(styrene-co-maleic anhydride/acid) copolymer further comprises the use of Tangential Flow Filtration, wherein the poly(styrene-co-maleic anhydride/acid) copolymer and alkaline water form a homogenous mixture.

In certain embodiments, the method of purifying a poly(styrene-co-maleic anhydride/acid) copolymer further comprises the use of Tangential Flow Filtration, wherein the Tangential Flow Filtration has a molecular weight cutoff of about 70 KD or less.

In certain embodiments, the method of purifying a poly(styrene-co-maleic anhydride/acid) copolymer further comprises the use of Tangential Flow Filtration, wherein the Tangential Flow Filtration is continued until the content of the maleic acid in the supernatant is less than 0.1% by weight.

In certain embodiments, the method of purifying a poly(styrene-co-maleic anhydride/acid) copolymer further comprises the use of Tangential Flow Filtration, wherein the maleic acid in the supernatant is less than 0.01% or less.

In certain embodiments, the method of purifying a poly(styrene-co-maleic anhydride/acid) copolymer further comprises the use of Tangential Flow Filtration, wherein the temperature during the Tangential Flow Filtration is between 2° C. and 45° C.

In certain embodiments, the method of purifying a poly(styrene-co-maleic anhydride/acid) copolymer further comprises the use of Tangential Flow Filtration, further comprising maintaining the pH above 3.

In certain embodiments, the method of purifying a poly(styrene-co-maleic anhydride/acid) copolymer further comprises the use of Tangential Flow Filtration, further comprising precipitating the poly(styrene-co-maleic anhydride/acid) copolymer from the aqueous alkaline water by acidifying the mixture to a pH less than about 2.

In certain embodiments, the method of purifying a poly(styrene-co-maleic anhydride/acid) copolymer further comprises the use of Tangential Flow Filtration, wherein the mixture is acidified by adding an acid selected from the group consisting of hydrochloric acid, hydrobromic acid, hydrofluoric acid, hydroiodic acid, nitric acid, sulfuric acid, perchloric acid, fluoroantimonic acid (HFSbF₅), magic acid (FSO₃HSbF₅), carborane superacid (CHB₁₁Cl₁₁)), fluorosulphuric acid (FSO₃H), phosphoric acid, chromic acid, formic acid, acetic acid, trifluoroacetic acid, tartaric acid, citric acid, ascorbic acid; methanesulfonic acid, trifluoromethane sulfonic acid, toluenesulfonic acid, or mixtures thereof.

In other embodiments, the copolymer is further purified via dialysis of the poly(styrene-co-maleic anhydride/acid) copolymer.

In certain embodiments, the copolymer is further purified via dialysis of the poly(styrene-co-maleic anhydride/acid) copolymer wherein the poly(styrene-co-maleic anhydride/acid) copolymer is in an aqueous solution, and the solution is maintained at a pH of less than 3.

In certain embodiments, the copolymer is further purified via dialysis of the poly(styrene-co-maleic anhydride/acid) copolymer wherein the copolymer is in an aqueous solution, and the solution is maintained at a pH of greater than 6.

In certain embodiments, the copolymer is further purified via dialysis of the poly(styrene-co-maleic anhydride/acid) copolymer wherein the dialysis occurs for a period of about 1-24 hours.

In certain embodiments, the copolymer is further purified via dialysis of the poly(styrene-co-maleic anhydride/acid) copolymer; and the poly(styrene-co-maleic anhydride/acid) copolymer is precipitated by acidifying the aqueous solution to a pH of less than 2.

In certain embodiments, the copolymer is further purified via dialysis of the poly(styrene-co-maleic anhydride/acid) copolymer; the poly(styrene-co-maleic anhydride/acid) copolymer is precipitated by acidifying the aqueous solution; and the solution is acidified by addition of an acid selected from the group consisting of hydrochloric acid, hydrobromic acid, hydrofluoric acid, hydroiodic acid, nitric acid, sulfuric acid, perchloric acid, fluoroantimonic acid (HFSbF₅), magic acid (FSO₃HSbF₅), carborane superacid (CHB₁₁Cl₁₁)), fluorosulphuric acid (FSO₃H), phosphoric acid, chromic acid, formic acid, acetic acid, trifluoroacetic acid, tartaric acid, citric acid, ascorbic acid; methanesulfonic acid, trifluoromethane sulfonic acid, toluenesulfonic acid, or mixtures thereof.

In other embodiments, the copolymer is further purified via use of supercritical fluid extraction. In certain embodiments, the copolymer is further purified via use of supercritical fluid extraction wherein the supercritical fluid is supercritical carbon dioxide. In certain embodiments, the copolymer is further purified via use of supercritical fluid extraction wherein the purifying does not comprise the use of organic solvents.

By way of example of a method of preparing a poly(styrene-co-maleic anhydride/acid) that can be purified according the method of the present invention, the method of WO 2007/115165, and comprises the steps of:
(a) melting an amount of maleic anhydride monomer;
(b) adding an amount of styrene containing dissolved initiator to the maleic anhydride to form a mixture;
(c) mixing the maleic anhydride, styrene, and initiator mixture for an effective amount of time to form a copolymer; and
(d) removing unreacted styrene, maleic acid and maleic anhydride monomers from the copolymer.

In some embodiments, the maleic anhydride serves as both as a reaction medium and a reactant. In some embodiments, the solvents that are absent from the method are organic solvents. Thus, the end product is not contaminated with organic solvents, thereby avoiding the step of removing and disposing of such organic solvents.

Examples of suitable initiators for initiating polymerization include the customary agents which form free radicals by thermal decomposition. Non-limiting examples include: diacyl peroxides, such as dibenzoyl peroxide, di-tertbutyl peroxide, tert-butyl perbenzoate or tert-butyl perethylhexanoate peresters, such as tert-butyl perpivalate, aliphatic azo compounds, such as 2.2′-azoisobutyronitrile, azo-4-cyanopentanoic acid or other water-soluble aliphatic azo compounds, salts of peroxodisulphuric acid or hydrogen peroxide. In one embodiment, the initiator is dibenzoyl peroxide or azoisobutyronitrile. In some embodiments, the amount of styrene and the amount of maleic anhydride have a ratio (styrene:maleic anhydride) of between about 1:6 and about 1:14 by weight of the reaction feed. In other embodiments, the ratio is between about 1:8 to about 1:12 by weight.

In some embodiments, the amount of the initiator is between about 0.01% and about 0.05% by weight of the total reaction mixture, i.e., the combined, styrene, maleic anhydride and initiator, while in other embodiments, the initiator is between about 0.025% and about 0.035% of the weight of the reaction mixture.

The maleic anhydride is melted by heating the maleic anhydride to at least its melting point. In some embodiments, the melting of the maleic anhydride is carried out by heating the maleic anhydride to about 51° C. to about 56° C. In other embodiments, the maleic anhydride is heated to a temperature of about 55° C. to about 80° C., or to about 65° C. In some embodiments, the styrene is added to the maleic anhydride while maintaining the reaction mixture temperature in a range of about 56° C. and about 100° C.

In certain embodiments, the initiator is a free radical initiator. The initiator has an initiation temperature, e.g., benzoyl peroxide has an initiation temperature around 80° C. Accordingly, the mixing of the maleic anhydride, styrene, and initiator is carried out at a temperature of at least the initiation temperature of the initiator. In some embodiments, the reaction is carried out at atmospheric pressure.

In certain embodiments, the copolymer formed in step (c) of the aforementioned method consists essentially of poly(styrene-co-maleic anhydride). This poly(styrene-co-maleic anhydride) contains styrene units and all or substantially all maleic anhydride units, and contains zero, or a very small percentage of maleic acid units.

In other embodiments, the copolymer of step (c) is poly(styrene-co-maleic anhydride/acid).

In some embodiments, a portion of the maleic anhydride monomer is hydrolyzed to maleic acid prior to forming the copolymer. When the maleic anhydride monomer is hydrolyzed to form a mixture of maleic acid and maleic anhydride, the resulting copolymer formed in step (c) is poly(styrene-co-maleic anhydride/acid).

In some embodiments, the method further comprises adding water to the copolymer formed in step (c). In some embodiments, the water hydrolyzes unreacted maleic anhydride monomers, maleic anhydride units in the copolymer, or both.

In some embodiments, the method further comprises hydrolyzing a portion of the maleic anhydride units in the copolymer. In some embodiments, 10-85% of the maleic anhydride units of the copolymer are hydrolyzed by adding water to the copolymer. When the copolymer formed in step (c) is poly(styrene-co-maleic anhydride), the step of hydrolyzing 10 to 85% of the maleic anhydride units provides a poly(styrene-co-maleic anhydride/acid) copolymer having about 10 to 85% maleic acid units.

In some embodiments, the amount of water added is between about 5% and 40% by weight of the copolymer, or between 10% and 35% by weight of the copolymer.

In some embodiments, the aforementioned method further comprises cooling the copolymer to room temperature. For example, the copolymer may be cooled to a temperature in a range of about room temperature to about 65° C. In some embodiments, the copolymer is cooled to room temperature, e.g. about 25° C. In some embodiments, the cooling occurs when the water is added to the copolymer.

In some embodiments, the method further comprises extracting unreacted maleic anhydride and/or maleic acid from the copolymer with water. For example, the copolymer formed in step (c) is mixed with a quantity of water about 6 times the weight of the copolymer to hydrolyze the unreacted maleic anhydride, and extract maleic acid from the copolymer. The water can be removed from the copolymer by filtration. In some embodiments, the aforementioned extraction step is repeated until the content of maleic acid in the removed water, also called the supernatant, is less than about 0.001% by weight.

In some embodiments, the washing is carried out at a temperature of about 5° C. to about 40° C., or about 15° C. to about 35° C.

In some embodiments, the washing cycles are carried out for less then 1 hour.

In some embodiments the copolymer is maintained in a wet state.

In some embodiments, the methods further comprises drying the copolymer at a temperature between about 50° C. and about 90° C., or between about 60° C. and about 80° C. In some embodiments, the copolymer is dried under a vacuum of about 50 mbar or less. In some embodiments, the copolymer is dried until its moisture content is less than about 20%.

As described in WO 2007/115165, polymeric reactions can be carried out, for example, in a kneader-extruder (such as Sigma Mixer by Jaygo, Union, N.J., USA) connected to a vacuum that includes a trap for condensed water cooled at temperature of 5-7° C., a heating-cooling mantle, thermometer, and dosing funnel for liquids, in which is loaded at ambient temperature a predetermined quantity of technical grade maleic anhydride. The maleic anhydride is mixed at temperatures of about 75° C. for about 30 minutes to yield a transparent fluid mass of melted maleic anhydride. A persistent semi-opaque melt indicates the presence of maleic acid. Transforming maleic acid to maleic anhydride can be achieved by connecting the kneader to a vacuum distillation apparatus and adjusting the pressure to 400 mbar at the above temperature for about 30 minutes. The maleic anhydride melts at atmospheric pressure is brought to a temperature not less than 55° C. and not greater than 100° C. In another embodiment, the temperature is between 65° C. and 90° C. A separate vessel is charged with technical grade styrene and an initiator is added to the styrene. The resulting solution is added to the melted maleic anhydride. Mixing is continued at atmospheric pressure and a temperature not less than 60° C. and not greater than 150° C. for a period of time not less than 45 minutes and not greater than 300 minutes. In another embodiment the mixing temperature is maintained between 85° C. and 115° C. In another embodiment, the mixing time is between 60 and 180 minutes.

The yellow-brown, viscous and transparent reaction mass is processed to transform unreacted excess maleic anhydride to maleic acid by hydrolysis. The content of the kneader is cooled to not less than 55° C. and not greater than 85° C. by adding purified water. In another embodiment, the content of the kneader is cooled to temperatures between 60° C. and 80° C. The amount of purified water added is not less than 5% and not greater than 40% by weight versus the reaction mass. After completing the addition of the water, the reaction mass is continued to be mixed. Alternatively, the reaction mass is cooled to ambient temperatures by circulating through the mantle liquid with temperatures of 5-7° C.

The maleic acid is extracted from the reaction mass according to the following process: a stainless steel mixing vessel (such as Nutsche filter, Rosenmund filter, etc.) equipped with an impeller stirrer with two or more blades, a mantle for heating or cooling, a thermometer, a dosing nipple for liquids, an inlet-pipe connection for compressed air, an outlet nipple, and, in the interior, a filter based on two pierced stainless steel plates with a polyamide cloth (100 micron mesh) between them. The vessel is having a useful volume three times larger than that of the kneader. The vessel is filled with purified water in an amount that is approximately six times the volume of the reaction mass at a temperature not less than 5° C. and not greater than 40° C. In another embodiment, the temperature is between 15° C. and 35° C. While stirring the purified water at a stirring rate of 40-60 rpm the reaction mass is added via the helical conveyer. The formed aqueous suspension is stirred for not less than 1 hour and not greater than 6 hours. In another embodiment, the suspension is mixed between 2 and 4 hours. The stirring is stopped and the aqueous phase is eliminated by filtration under pressure.

The extraction process is repeated for as many times as it takes to obtain a maleic acid content in the supernatant of less than 0.001% by weight as determined by volumetric titration with a solution of NaOH 0.01 N.

The wet solid, substantially free of the maleic acid, and with a moisture content of 70%, is transferred to a circular dryer equipped with a heating and cooling mantle, thermometer, helicoidally stirrer, breaking device with rotary knife, and is connected to a vacuum distillation apparatus comprising a filter with sackcloth, condenser, and collecting vessel for the condensation water. The granular mass is dried at a temperature of not less than 50° C. and not greater than 45° C. In another embodiment, the drying temperature is between 15° C. and 35° C., and the vacuum is at 50 mbar for a period of time not less than 4 hours and not more than 10 hours. In another embodiment, the drying period of time is between 6 and 8 hours. Lastly, the material is cooled to ambient temperature, removed from dryer, and packed in welded polyethylene bags.

The aqueous solution of maleic acid resulting from the extraction is processed by thermal dehydration to obtain maleic anhydride using one of the proceeding known methods in art and adapted to the present invention (see for example U.S. Pat. No. 3,993,671; U.S. Pat. No. 4,118,403; U.S. Pat. No. 4,414,898 and U.S. Pat. No. 4,659,433).

The acid wash for purifying poly(styrene-co-maleic anhydride/acid), is conducted in a stainless steel mixing vessel (such as Nutsche, Rosenmund filter, etc.) as described above. The vessel is filled with purified water in an amount that is approximately six times the volume of the reaction mass at a temperature not less than 5° C. and not greater than 45° C. In another embodiment, the temperature is between 15° C. and 35° C. While stirring the purified water at a stirring rate of 40-60 rpm the reaction mass is added via the helical conveyer. The formed aqueous suspension is stirred for not less than 1 hour and not greater than 6 hours. In another embodiment, the suspension is mixed between 2 and 4 hours. The stirring is stopped and the aqueous phase is eliminated by filtration under light pressure.

The extraction process is repeated for 3-6 times with water, which causes the polymer to swell. In order to collapse the swollen polymer, the poly(styrene-co-maleic anhydride/acid) is washed in acidic water, wherein the aqueous media's pH is in a range of about 2 to about 4. The acidic solution, which is in contact with the poly(styrene-co-maleic anhydride/acid), should have a pH and acid content sufficient to cause the polymer to collapse and to extract the monomers, such as maleic acid and maleic anhydride, and low molecular weight fragments of the polymer. Accordingly, the acid washing operation is carried out in a batch fashion, so that the proper amount of acid can be added to a fixed volume of crude polymer. While not being bound by any particular theory, the amount of acid added to the polymer is important, since too high pH fails to cause the polymer to collapse and to remove the impurities as the poly(styrene-co-maleic anhydride/acid) will start to absorb water, swell and in the swelling process adsorbs the low molecular weight contaminates. On the other hand, at a too low pH adversely reverses the washing process as the contaminates precipitate with the polymer and cannot be washed.

The wet collapsed polymer is washed several times with cold purified water (<10 C) to remove the residual acidity.

The process could be customized to alternate between water washes and acidic water washes as required by the filtration process.

The wet solid, substantially free of the maleic and styrene monomers, and with a water content of 70-90%, could be transferred to an air drying unit (such as a Gruenberg Granulation Dryer or Glatt Fluidizer bed). The granular mass is dried at a temperature of 50-90° C. Lastly, the material is cooled to ambient temperature, removed from the dryer, and packed in welded polyethylene bags.

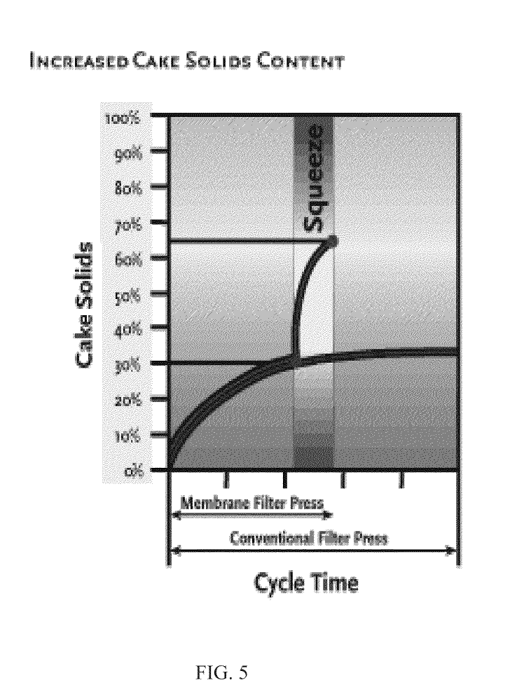

In a further embodiment, the water is removed by a filter-press. Poly(styrene-co-maleic anhydride/acid) swells in aqueous environment at pH>3, which occurs after 2-3 wash cycles with water. As a result conventional filtration cannot remove the bound water. By applying a high pressure membrane squeeze to the formed filter cake with pressurized fluid (50 psi or even higher), it is possible to produce a final cake with solids content from 50% to 100% greater than can be achieved with conventional filters. This is important for obtaining maximum yield, by producing a high solid content cake, where it is critical to reduce moisture content. FIG. 5 demonstrates the increased cake solid content of a filter-press vs. traditional filtration (from Avery Filter Company, Inc. Technical Information).

A filter-press improves also the cake washing efficiency and reduces wash time by applying a low-pressure pre-squeeze before the wash cycle is begun. This pre-squeeze produces a uniform filter cake, eliminating wash liquid channeling through cracks and less well formed areas of the cake.

The filter-press consists of three components: a circulation/feed pump, filter plates, and a pneumatic bladder inside each plate. Plates are covered with filter cloths of a prescribed porosity, available in polypropylene, polyester, nylon, etc. The poly(styrene-co-maleic anhydride/acid) is suspended in aqueous media in a vessel and diverted to the cavity between the plates by a pump. Liquid passes through the cloth filter, while the solids are retained in the cavity. After all the liquid has been pumped through, the solids, swollen with liquid, are squeezed against the filter plated by expanding the pneumatic bladder with compressed gas (such as air or nitrogen). Pressure is maintained for a few minutes and the released. The compressed cake can then be partially dried by blowing inert gas through the feed-lines. After compression and possibly air drying the press is opened and material either fall into a receiving pan below the filter-press unit or could be hand scooped out of the cavities. The press is then flushed and cleaned and readied for the next batch.

This process could be done after each wash cycle or at predetermined points in the wash process.

The ideal pressure that the bladder applies on the poly(styrene-co-maleic anhydride/acid) is between 50 and 200 psi.

In a further embodiment, the water is removed by a continuous process using filter-press.

In a further embodiment, the water is removed by a basket centrifuge. A basket centrifuge provides an improved flow orientation, reduce turbulence, and in general improve the effectiveness of the filtration. Furthermore, when applying high centrifugal force the swollen poly(styrene-co-maleic anhydride/acid) is pressed under its own weight and most of the water is being removed. The solids are removed by the knife blades are discharged through an opening in the bottom of the centrifuge bowl, and are conveyed away by appropriate means.

In a further embodiment, the water is removed by a continuous process using a basket centrifuge.

In a further embodiment, the water is removed by compassing the wet polymer filter-cake between rollers using a belt filter-press. The belt-press is a dewatering machine designed to concentrate sludge by means of progressive compression between two permeable belts. The “low pressure” zone of the filter features the upper and lower belt converging to gradually begin exerting pressure on the sludge. The belts containing the sludge wrap around a large diameter perforated roll that exerts a moderate and uniform pressure, separating free water from the sludge. The “high pressure” compression zone consists of 5 or 7 rolls around which the two belts containing the sludge are pressed. The pressure rolls feature a progressively decreasing diameter along the working direction of the machine. In this configuration the pressure exerted on the sludge gradually increases to produce a high dry value in the final cake. Processed cake is removed from the belts by upper and lower belt doctor blades. The belts are then cleaned by a washing station in preparation for another pass through the press.

In a further embodiment, the water is removed from poly(styrene-co-maleic anhydride/acid) by high pressure at temperatures below 45° C.

In a further embodiment, the water, residual monomers and low molecular weight poly(styrene-co-maleic anhydride/acid) are removed by Tangential Flow Filtration.

In a further embodiment, poly(styrene-co-maleic anhydride/acid) is solubilized in aqueous media to form an homogenous solution and the water, residual monomers and low molecular weight poly(styrene-co-maleic anhydride/acid) are removed by Tangential Flow Filtration.

In a further embodiment, the water is removed by Tangential Flow Filtration with a molecular weight cut off membrane 3-6 times smaller than the MW of molecules to be retained.

In a further embodiment, the water is removed by Tangential Flow Filtration with a molecular weight cut off membrane of 15-35 KD.

In a further embodiment, the first 2 washes are done by filtration under pressure followed by Tangential Flow Filtration.

In a further embodiment, the Tangential Flow Filtration is continued until the content of maleic acid in the supernatant is less than 0.1% by weight.

In a further embodiment, the Tangential Flow Filtration is continued until the content of maleic acid in the poly(styrene-co-maleic anhydride) is less than 0.01% by weight.

In a further embodiment, the Tangential Flow Filtration is continued while maintaining the system at a temperature between 2° C. and 45° C.

In a further embodiment, the Tangential Flow Filtration is continued while maintaining the system's pH above 3.

In a further embodiment, the Tangential Flow Filtration is continued while maintaining the system's pH above 3 and the temperature between 2° C. and 45° C.

In another embodiment of the invention, the washing is conducted using a Tangential Flow Filtration with a molecular weight cut off above 15 KD.

In another embodiment of the invention, the washing is conducted by dissolving the crude the poly(styrene-co-maleic anhydride/acid) in basic water and using a Tangential Flow Filtration with a molecular weight cut off above 15 KD.

In a further embodiment of the invention, the poly(styrene-co-maleic anhydride/acid) previously subjected to Tangential Flow Filtration is precipitated from the basic aqueous media by acidifying the solution to about pH<2. For example, the poly(styrene-co-maleic anhydride/acid) is dissolved in basic media (e.g., NaOH solution, pH 8) and subjected to tangential flow filtration over 6 hours. Afterwards the poly(styrene-co-maleic anhydride/acid), which is free of monomers and low molecular weight containments, is precipitated from the basic aqueous media by acidifying the solution to pH<2.

In a further embodiment, the free maleic acid is removed by dialysis.

In a further embodiment, the free maleic acid is removed by dialysis until the content of maleic acid in the supernatant is less than 0.01% by weight.

In a further embodiment, the dialysis is continued while maintaining the system's pH below 3.

In a further embodiment, the dialysis is continued while maintaining the system's pH above 6.

Membrane filtration is a separation technique widely used (for an overview on the subject see Perry's Chemical Engineers' Handbook 7th Edition, McGraw-Hill, 1997). Depending on membrane porosity, it can be classified as a microfiltration or ultrafiltration process. Microfiltration membranes, with pore sizes typically between 0.1 μm and 10 μm, are generally used for clarification, sterilization, and removal of microparticulates or for cell harvesting. Ultrafiltration membranes, with much smaller pore sizes between 0.001 and 0.1 μm, are used for concentrating and desalting dissolved molecules, exchanging buffers, and gross fractionation. For polymer purifications, the membranes are typically classified by molecular weight cutoff (MWCO) rather than pore size.

There are two main membrane filtration modes which can use either microfiltration or ultrafiltration membranes: 1) Direct Flow Filtration (DFF) where the feed stream is applied perpendicular to the membrane face and attempts to pass 100% of the fluid through the membrane and 2) Tangential Flow Filtration (TFF), also known as cross-flow filtration, where the feed stream passes parallel to the membrane face as one portion passes through the membrane (permeate) while the remainder (retentate) is recirculated back to the feed reservoir. (Larry Schwartz and Kevin Seeley, in a technical article by Scientific and Laboratory Services of Pall Corporation).

When using TFF the flow of sample solution across the membrane surface sweeps away aggregating molecules that form a membrane-clogging gel (gel polarization), allowing molecules smaller than the membrane pores to move toward and through the membrane. Thus, TFF can be faster and more efficient than DFF for size separation.

Two of the important variables involved in all tangential flow devices are transmembrane pressure (TMP) and cross-flow velocity (CF).
1. The transmembrane pressure is the force that drives fluid through the membrane, carrying along the permeable molecules.
2. The crossflow velocity is the rate of the solution flow through the feed channel and across the membrane. It provides the force that sweeps away molecules that can foul the membrane and restrict filtrate flow.

Fluid is pumped from the sample reservoir into the feed port, across the membrane surface (cross-flow), out the retentate port and back into the sample reservoir. The cross-flow sweeps away larger molecules and aggregates that are retained on the surface of the membrane, preventing gel polarization (the formation of a concentrated biomolecule layer on the membrane surface that can foul or plug the membrane). Liquid flowing through the narrow feed channel creates a pressure drop between the feed and retentate ports. This pressure, which is applied to the membrane, can be further increased by increasing the cross-flow rate or by restricting the tubing at the retentate port. This transmembrane pressure (TMP) is the force that drives liquid through the membrane. The liquid that flows through the membrane (filtrate or permeate) carries molecules smaller than the membrane pores through the filter.

Dialysis is another procedure for reducing the low molecular weight by products in samples. It requires filling a dialysis bag (membrane casing of defined porosity), tying the bag off, and placing the bag in a bath of water or buffer. Through diffusion, the concentration of the low molecular weight by products in the bag will equilibrate with that in the bath. Large molecules that can't diffuse through the bag remain in the bag. If the bath is water, the concentration of the low MW molecules in the bag will decrease slowly until the concentration inside and outside is the same. The greater the volume of the bath relative to the sample volume in the bags, the lower the equilibration concentration that can be reached. Usually several replacements of the bath water are required to completely remove all of the salt. The final volume in the bag is similar to the starting volume though it may have changed a little due to osmotic effects. Once equilibration is complete, the bag is ruptured and the solution poured off into a collection vessel.

Dialysis is quite slow, taking as much as several days for almost complete salt removal. It also requires manual manipulation of the dialysis bags for filling and tying off. The requirement for manual manipulation increases the chances for accidental breakage of the bags. While dialysis can be used for volumes up to a few liters, it is not practical for larger sample volumes and therefore is particularly not suited for industrial uses.

The dialysis process could take place on either the suspension of a solid in media while the low molecular-weight fragments are removed from the dialysis beg. Alternatively, dissolving the material in an aqueous mediand subjecting the resulting homogenous solution to the dialysis process.

In another embodiment the poly(styrene-co-maleic anhydride/acid) is purified by super critical fluids. Supercritical fluids are highly compressed gases which combine properties of gases and liquids. Fluids such as supercritical xenon, ethane and carbon dioxide offer the ability to purify the polymer. Each polymer is charged individually to an extraction vessel, and CO₂ at selected pressure and temperature conditions is passed through the vessel for a period of time. (It's not actually time, but total mass of gas that is the important variable since the flow rate is adjustable; time is easy to relate to.) The high-pressure stream of CO₂ plus extracted material is then passed through a pressure reduction valve into a collector where the extractables precipitate (the extract). The atmospheric CO₂ exits the collector and is totalized over the course of the test. The biocompatible poly(styrene-co-maleic anhydride/acid) is left in the extractor (the residue) is then removed and weighed.

Characterization of Poly(Styrene-Co-Maleic Anhydride/Acid) with Low Residual Monomers

Poly(styrene-co-maleic anhydride/acid) copolymers prepared in conformity with the methods described above have the following characteristics:

1. Sty:Mal=40:60-60:40 weight percent (styrene/[maleic anhydride+maleic acid]).
2. MAnh/Mal=less than about 0.8.
3. Molecular weight average above 500,000.
4. Styrene residual less than 0.002% weight percent.
5. Mal (maleic anhydride+maleic acid) residual=less than 0.001 weight percent.

The residual monomer content from poly(styrene-co-maleic anhydride/acid) has been determined by the following procedures:

(a) The amount of residual styrene can be measured by extraction with benzene (spectroscopic grade) of 1 g of polymer for 12 hours by Sohxlet extraction. The benzene extractions were then analyzed by gas spectroscopy (Perkin-Elmer equipment).

The amount of residual styrene, the initiator benzoyl peroxide and its byproduct benzoic acid, and the styrene stabilizer—4-tert-butylcatechol was measured by reverse phase HPLC method utilizing Agilent, Zorbax SB-C18, 250×4.6, 5 μm column, a mobile phase made of: A: 0.1% v/v Acetic Acid in Water; and B: 0.1% v/v Acetic Acid in Acetonitrile; analyzed at 270 nm. The retention time of the peaks in the chromatogram of the Sample Solution corresponds (±2%) to that in the chromatogram of the Working Standard Solution with the following gradient at 25° C.:

| Time (min) | % A | % B |
|---|---|---|
| 0 | 55 | 45 |
| 10 | 55 | 45 |
| 20 | 40 | 60 |
| 30 | 40 | 60 |
| 31 | 20 | 80 |
| 40 | 20 | 80 |
| 41 | 55 | 45 |
| 50 | 55 | 45 |

The detection limit of residual styrene using this method is 0.002%. The amounts of benzoyl peroxide, benzoic acid, and the styrene stabilizer 4-tert-butylcatechol are also 0.002%.

The amount of residual styrene could also be measured accurately by a head-space gas chromatograph method. The method utilized an Agilent 7694 Headspace (HS) Sampler, a Hewlett-Packard 6890 GC equipped with a FID. The column was SUPELCO SPB-1, 15 m×0.53 mm I.D., 1.5 μm film thickness, or equivalent. Data was processed by HP ChemStation/Chemstore Laboratory Data System or equivalent integrating device.

A poly(styrene-co-maleic anhydride/acid) was weighed accurately into an empty HS vial. The seal was crimped.

The auto sampler Conditions

Sample vial temperature 110° C.

Loop temperature 220° C.

Transfer temperature 220° C.

GC cycle time 15 min

Vial equilibration time 15 min

Pressurization time 3 min

Loop fill time 0.15 min

Loop equilibration time 0.05 min

Injection time 0.1 min

Carrier gas: Helium 2.5 ml/min

GC-FID conditions

Injector temperature: 200° C.

Temperature program: 50° C. held for one minute, raised at 30° C.

/min to 220° C., held for three minutes.

Carrier gas: Helium 4 ml/min

Carrier gas split ratio: 1:1

FID: 250° C.; Hydrogen 30 mL/min, Air 350 mL/min.

This GC-head space method provides limit of detection equal to 1.24 ppm and limit of quantification equal to 2.49 ppm of styrene.

(b) The amount of residual maleic acid was measured by dialysis with distilled water of a 2 g sample of polymer at 40° C. using a Spectr/Por CE dialyze membrane in 14 cycles of 24 hours each (500 ml water per cycle), the water was changed after each cycle. The accumulated water was analyzed for maleic acid by HPLC method (Waters equipment).

Maleic acid residue was also measured by reverse phase HPLC utilizing Resteck, Allure Acidix, 250×4.6, 5 μm column, Ammonium Acetate Buffer pH 4.5: Acetonitrile (20:80) mobile phase, analyzed at 220 nm; the retention time of the peak in the chromatogram of the Sample Solution corresponds (±2%) to that in the chromatogram of the Working Standard Solution. The detection limit using this method of residual maleic acid and maleic anhydride combined is 0.001%.

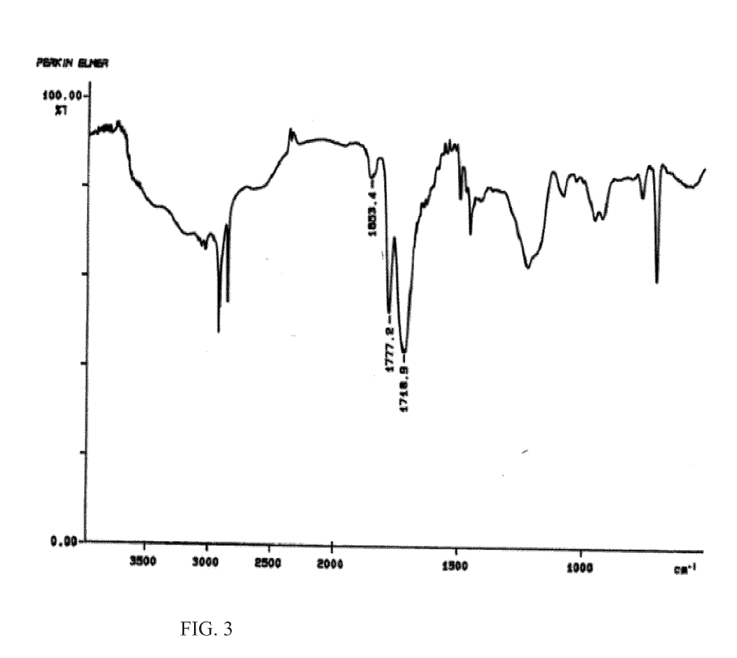

(c) Monomeric concentration expressed as Sty:Mal (styrene:maleic comonomer [maleic anhydride+maleic acid]) was estimated by conductometric titration of a solution prepared by dissolving 0.1 g of dry polymer in a solution of NaOH 0.5 N and HCl 0.5N.
(d) Functionality ratio, expressed as MAnh:Mal (maleic anhydride [maleic anhydride+maleic acid]), [(mol/g):(mol/g)], was estimated using FTIR quantitative analysis. Fourier Transform Infrared Spectra of poly(styrene-co-maleic anhydride/acid) acquired in accordance with USP29-NF24 <197S>. 50 mg of poly(styrene-co-maleic anhydride/acid) was dissolved in 2 mL of methanol (vortex and or sonicate if necessary). Approximately 200 μL of the solution was removed and cast over a polyethylene sample IR card. The solution allowed to air dry for 15-20 minutes. A heating gun may be used to facilitate the drying of the film, but care should be taken to avoid melting of the film. The IR spectrum (from ˜4000 cm⁻¹-500 cm⁻¹ and 4 cm⁻¹ resolution) was recorded using a plain polyethylene sample IR card as background. (FIG. 3).

A band between 1710 cm-1 and 1720 cm-1 corresponds to the carbonyl absorption in the maleic acid residues in the backbone. Note: This band may be smaller if heat is used in the preparation of the film. The band centered at approximately 1777 cm-1 corresponds to the carbonyl absorption of anhydride groups in the backbone. Note: This band may be larger if heat is used for preparation of the film. The region between 2500-3800 cm-1 contains bands corresponding to the oxygen-hydrogen stretching vibrations of carboxyl groups.

(e) Viscosimetric average molecular weight, Mᵥ, was estimated using the evaluation of intrinsic viscosity [ηᵣₑₗ] based on relative viscosity [η] of one solution of polymer with concentration c=0.5 g/100 ml in tetrahydrofuran at 25° C., using the calculus formulae (Raju K. V. S. N., Yaseen M. J. Appl. Polym. Sci., 45, 677-681, 1992; Chee K. K. J., Appl. Polym. Sci., 34, 891-899, 1987 and Spiridon D. et al. Polymer International, 43, 175-181, 1997).

$$[ η ] = \frac{\sqrt{2 ( {η}_{rel} - Ln ( {η}_{rel} ) - 1 )}}{c} \\ [ η ] = 0.77 * {10}^{- 4} * {M}_{V}^{0.725}$$

Absolute Molecular weight of the poly(Styrene-co-maleic anhydride/acid) was also determined by Gel Permeation Chromatography (GPC) coupled with multi angle light-scattering detection (SEC-MALLS). The polymer was dissolved in either DMSO or water. The analysis was performed using a PLGel 34-5/34-2 column (or equivalent) at 60° C. with a flow rate of 1 mL/min. Results are below.

The ratio between the styrene and maleic anhydride/acids units in the polymer is determined by ¹H NMR. Poly(styrene-co-maleic anhydride/acid) was dissolved in NaOD solution at 70° C. and after filtration was analyzed by high field NMR.

The ratio of the aromatic peak (˜7 PPM, relates to Styrene) to the aliphatic peak (˜2 PPM relates to maleic acid) is around 1:1, indicating that the resulting polymers have a substantial equal amounts of styrene and maleic acid building units.

Further examples for realizing the invention are presented below.

### EXAMPLES

The invention now being generally described, it will be more readily understood by reference to the following examples, which are included merely for purposes of illustration of certain aspects and embodiments of the present invention, and are not intended to limit the invention.

### Example 1

The following is an example of synthesizing poly(styrene-co-maleic anhydride/acid) as described in WO 2007/115165.

In a Sigma mixer (60 liters) equipped with cooling and heating jacket, thermometer, and dosing funnel for liquids, 25 kg of technical grade maleic anhydride (Technical grade, Bayer) was added at ambient temperatures. The maleic anhydride was melted at 65° C. In a separate reactor charged with chilled 3.3 Kg of styrene (Technical grade, GADOT Chemical Terminals, LTD, Israel) 8 g of dibenzoyl peroxide (Merck) was added. The resulting mixture was transferred under ambient pressure over 20 minutes to the melted maleic anhydride in the Sigma mixer while maintaining the temperature in the Sigma between 65 and 75° C. After the addition of the styrene/benzyl peroxide mixture, the temperature of the reaction increased rapidly during a period of 15 minute from to 110° C. due to the initiation of the polymerization. When the exothermic phase of polymerization is completed, mixing was continued at 100° C. for another 60 minutes. The reaction mass was a viscous, transparent, yellow brown solution which was cooled to 65° C. by adding 8 liters of purified water while mixing over 60 minutes. After finishing adding the water, the reaction mass was mixed for another 45 minutes at 65° C. Alternatively, the reaction mass can be cooled to ambient temperatures by circulating cooled water (5-7° C.) through the mantle of the Sigma mixer.

The reaction mass was transferred to a Nutsche Filter equipped with heating and cooling jacket and a stirrer. The Nutsche contained 160 liters of purified water at 45° C. under moderate stirring (stirrer speed adjusted to 40-60 rpm). The Nutsche Filter has a usable volume three times larger than that of the Sigma mixer. The formed aqueous suspension was mixed for 1 hour. The aqueous phase was then removed by filtration under pressure.

The process was repeated twice by adding 120 liters of 0.05M HCl. Finally, the polymer was washed twice with 120 liters of cold water.

The wet solid had a water content of ˜70% and was transferred to an oven dryer. The wet mass was dried at 65° C. at 50 mbar for 5 hours. Lastly, the material was cooled to ambient temperature, removed from the dryer, and packaged in welded polyethylene bags.

From this process, 5.17 kg poly(styrene-co-maleic anhydride/acid) was obtained as a white powder and had ˜10% water.

### Example 2

Same equipment and procedure as described in Example 1 except that 3.4 liters of styrene having 6.8 grams of dibenzoyl peroxide dissolved therein was added at 65° C. Maximum temperature during the exothermic phase was 121° C.

After the addition of the reaction mass was transferred to a Nutsche Filter equipped with heating and cooling jacket and a stirrer. The Nutsche Filter contained 160 liters of purified water at 45° C. under moderate stirring (stirrer speed adjusted to 40-60 rpm). The Nutsche Filter has a usable volume three times larger than that of the Sigma mixer. The formed aqueous suspension was mixed for 1 hour. The aqueous phase was then removed by filtration under positive air pressure.

A solution of 0.05M NaOH was added and the poly(styrene-co-maleic anhydride/acid) was completely dissolved into solution after 8 hours of stirring at 45° C. The clear homogenous poly(styrene-co-maleic anhydride/acid) solution was purified using a Tangential Flow Filtration (Minimate™ from Pall Corp., East Hills, N.Y.) equipped with a Minimate™ Tangential Flow Filtration Capsule (modified polyethersulfone membrane with an effective molecular weight cutoff of 100,000 with effective filtration area 50 cm²). After 6 hours the resulting polymer has no detectable monomers and low molecular weight fragments of the polymer. This solution is acidified to pH<2.5 which causes the polymer to precipitate. The wet polymer is dried in a Gruenberg Granulation Dryer until the moisture content was <10% (by loss on drying).

This TFF process yielded a biocompatible poly(styrene-co-maleic anhydride/acid) with the typical characteristics as detailed below (see Example 3).

### Example 3

Same equipment and procedure as described in Example 1.

After the addition of the reaction mass was transferred to a Nutsche Filter equipped with heating and cooling jacket and a stirrer. The Nutsche Filter contained 160 liters of purified water at 45° C. under moderate stirring (stirrer speed adjusted to 40-60 rpm). The Nutsche Filter has a usable volume three times larger than that of the Sigma mixer. The formed aqueous suspension was mixed for 1 hour. The aqueous phase was then removed by filtration. The process was repeated by adding 120 liters of water at 30° C. followed by a wash with water at room temperature.

The swollen poly(styrene-co-maleic anhydride/acid) was transferred to a filter-press (470 mm filter press (the 470), Avery Filter Company, Inc., Westwood, N.J.). This filter-press consisted of three main components: a circulation/feed pump, filter plates, and a pneumatic bladder inside each plate. The plates were covered with nylon filter cloth with a porosity of 5 um. The polymer was circulated using the circulation/feed pump. When the circulation flow was robust, the flow was diverted to the cavity between the plates by switching a valve. The liquid passed through the filter cloth, while the solids were retained in the cavity. After all the liquid were pumped through the filter-press, the solids, swollen with liquid were squeezed against the filter plates by expanding the pneumatic bladder with compressed gas at 100 psi. This pressure was maintained for a few minutes and then released.

The compressed poly(styrene-co-maleic anhydride/acid) cake was removed from the filter-press and was washed with 120 liters of 0.05M HCl for 60 min. After removal of the acidic water, the polymer was washed twice with 120 liters of cold water. After each wash, the polymer was filtered in the filter-press as described.

The compressed cake was partially dried by blowing dry air through the feed lines, removed and was placed in an oven to be dried at 65° C. overnight. After 12 hours the polymer was allowed to cool to ambient temperature, removed from the dryer, and packaged in polyethylene bag that was placed in a polypropylene screw-top container.

This process yielded a biocompatible poly(styrene-co-maleic anhydride/acid) with the typical characteristics:

| | | Typical | |
|---|---|---|---|
| Test | Methods | Results | Limits |
| Appearance | Visual | White powder | White/gray |
| | | | powder |
| Identification | FTIR | Confirmed | Typical SMAc |
| | | | peaks |
| Identification | ¹H NMR | Confirmed | Conforms to |
| | | | Standard |
| Ratio Styrene/ | | 49.2/50.8 | Report Result |
| Maleic Acid | | | |
| Viscosity | Brookfield | 535 | 100 cP ÷ 700 cP |
| | viscometer | | |
| Molecular Weight | GPC | Mw - | |
| | | 987,190; Mn | |
| | | 516,000, Mz - | |
| | | 1,675,900 | |
| Molecular Weight | GPC | below | NMT 5000 ppm |
| <70,000 | | quantitation | |
| | | level | |
| Maleic Acid | RP-HPLC | 50 ppm | NMT 1000 ppm |
| Styrene | Head-space | below | NMT 280 ppm |
| | GC | quantitation | |
| | | level | |
| Benzoyl Peroxide | RP-HPLC | 60 ppm | NMT 5000 ppm |
| Benzoic Acid | | 21 ppm | NMT 5000 ppm |
| 4-tert- | | below | NMT 5000 ppm |
| Butylcatechol | | quantitation | |
| | | level | |
| Other Unknowns | | Not detected | Report Result |
| Water Content | Loss on | 6% | <15% |
| | Drying | | |
| Acid Number | Back Titration | 53% | |
| pH | pH Meter | 2.85 | 2.5-3.0 |

### Example 4

Same equipment and procedure as described in Example 3 except the wet poly(styrene-co-maleic anhydride/acid) is divided into two. One part is filtered using Compositech belt-press (Pearland Texas) and the second part is filtered using The Western States Machine Company (Hamilton, Ohio). Both filter cakes were dried in an oven and yield a biocompatible poly(styrene-co-maleic anhydride/acid) with typical characteristics as previously described (Example 3).

### Example 5

Same equipment and procedure as described in Example 3 except the wet poly(styrene-co-maleic anhydride/acid) (lots SMA 26-W6 and SMA 26-W8) was purified by super critical fluid extraction at Phasex Corp. (Lawrence, Mass.).

Poly(styrene-co-maleic anhydride/acid) was charged individually to an extraction vessel, and CO₂ at selected pressure and temperature conditions was passed through the vessel for a period of time. The high-pressure stream of CO₂ plus extracted material was then passed through a pressure reduction valve into a collector where the extractables precipitate (the extract). The atmospheric CO₂ exited the collector and was totalized over the course of the test. The purified poly(styrene-co-maleic anhydride/acid) that was left in the extractor (the residue) was then removed and weighed.

Each test was run at two different extraction conditions to remove the residual maleic acid. For each test, the entire charge was extracted at a first set of conditions (pressure and temperature); the extractor was degassed and a portion of the extracted material was removed; the extractor was sealed and the remaining polymer sample in the extractor was extracted at a second condition (higher pressure and temperature). The two tables below show the weight of the residue collected after each extraction condition.

TABLE 2
Test: BNX-1 Polymer SMA26-W6

| | Weight | |
|---|---|---|
| Fraction | (grams) | Observations |
| Charge (feed) | 9.49 | Small white polymer pieces |

Extraction Condition 1

| | | |
|---|---|---|
| BNX-1 extract 1 | 0.08 | Few small liquid drops |
| BNX-1 residue 1 | 2.54 | Noticed small amount of swelling after |
| (what was collected as | | extractor was opened. White pieces all |
| sample) | | “melted/swelled” together. |

Extraction Condition 2

| | | |
|---|---|---|
| BNX-1: extract 2 | 0.10 | Again, a few small drops of liquid |
| BNX-1: residue 2 | 2.70 | Noticed a lot of swelling after extractor |
| | | was opened. Residue foamed up upon |
| | | pressure let down. |

TABLE 3
Test: BNX-2 Polymer SMA26-W8

| | Weight | |
|---|---|---|
| Fraction | (grams) | Observations |
| Charge (feed) | 11.48 | Small white polymer pieces |

Extraction Condition 1

| | | |
|---|---|---|
| BNX-2 extract 1 | 0.89 | Largest amount of liquid collected as |
| | | extract in these two tests. Looks like a |
| | | lot of water. |
| BNX-2 residue 1 | 1.15 | Massive swelling upon pressure let- |
| (what was collected as | | down. Collect some of foamed residue |
| sample) | | and leave rest in extractor. |

Extraction Condition 2

| | | |
|---|---|---|
| BNX-2: extract 2 | 0.10 | A few small drops of liquid |
| BNX-2: residue 2 | 3.37 | Not much swelling noticed upon |
| | | pressure let-down. |

BNX 1-1 and BNX 1-2: did not exhibit a large reduction in the maleic acid content.

BNX 2-1: exhibited a small decrease in the amount of maleic acid residues (from 400-500 ppm to 300 ppm)

BNX 2-2: exhibited a significant decrease n the amount of maleic acid residues (from 400-500 ppm to 170 ppm.

### Example 6

Same equipment and procedure as described in Example 1 except that the ratio between maleic anhydride and styrene and the quantity of the initiator were varied. The resulting poly(styrene-co-maleic anhydride/acid) that were obtained were numbered as lots: P5, P7, P13, P14, P15, P17, P18 yellow and P18 white. The molecular weights of those products are given in the following table:

| | MW Fraction | Mn | Mw | Mz |
|---|---|---|---|---|
| Lot | Below 70,000 | (Daltons) | (Daltons | (Daltons) |
| | NMT 0.0011% | 1237000 | 1244000 | 1251000 |
| P5 | NMT 0.0013% | 756000 | 776000 | 794000 |
| P14 | NMT 0.0010% | 938000 | 954000 | 969000 |
| P15 | NMT 0.0020% | 805000 | 855000 | 900000 |
| P7 | NMT 0.0027% | 683000 | 727000 | 769000 |
| P18 | NMT 0.0002% | 845000 | 893000 | 937000 |
| P18 | NMT 0.0002% | 881000 | 924000 | 964000 |
| P17 | NMT 0.0001% | 614000 | 683000 | 740000 |

In addition, using elemental analysis and subtracting the water content (as determined by Karl Fisher water analysis or loss on drying method) yield same ratio of 1:1 of building units in the polymeric backbone for sample P13 is given below:

TABLE 5
Elemental Analysis calculations based on ¹H NMR and Karl Fisher Water Analysis
data

| | C | H | N | O | Mwt | % | C | H | N | O |
|---|---|---|---|---|---|---|---|---|---|---|
| Molecular | 12.011 | 1.0079 | 14.01 | 15.9993 | | | | | | |
| Weight | | | | | | | | | | |
| Styrene | 7 | 8 | 0 | 0 | 92.14 | 44.9 | 41.0 | 3.9 | 0 | 0 |
| Maleic | 4 | 4 | 0 | 4 | 116.07 | 45.0 | 19.0 | 1.6 | 0 | 25.3 |
| Acid | | | | | | | | | | |
| Water | 0 | 2 | 0 | 1 | 18.02 | 9.1 | 0 | 1.0 | 0 | 8.1 |
| Composite | | | | | | 100.0 | 60.0 | 6.5 | 0 | 33.4 |
| | | | | | Results | 60.4 | 5.1 | 0.6 | | |
| | | | | | Variance | 0.4 | −1.4 | 0.6 | | |

### INCORPORATION BY REFERENCE

All of the U.S. patents and U.S. published patent applications cited herein are hereby incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claim.

While this invention has been particularly shown and described with references to preferred embodiments thereof, it will be understood by those skilled in the art that various changes in form and details may be made therein without departing from the scope of the invention encompassed by the appended claims.

1. A poly(styrene-co-maleic anhydride/acid) copolymer comprising less than 0.01% by weight of styrene monomers, and less than 0.2% by weight of maleic acid and maleic anhydride monomers combined.

2. The poly(styrene-co-maleic anhydride/acid) copolymer of claim 1, comprising less than 0.002% by weight of styrene monomer.

3. The poly(styrene-co-maleic anhydride/acid) copolymer of claim 2, wherein the styrene is undetectable using an analytical method with a threshold detection level of 0.061 microgram/mL or less.

4. The poly(styrene-co-maleic anhydride/acid) copolymer of claim 1, wherein the styrene is undetectable by reverse phase HPLC with a detection limit for styrene of 0.002% or less.

5. (canceled)

6. The poly(styrene-co-maleic anhydride/acid) copolymer of claim 1, comprising less than 0.01% or less of maleic acid and maleic anhydride combined.

7. (canceled)

8. The poly(styrene-co-maleic anhydride/acid) copolymer of claim 1, wherein the maleic acid and maleic anhydride are undetectable using an analytical method having a threshold detection level of 0.036 microgram/mL or less.

9. The poly(styrene-co-maleic anhydride/acid) copolymer of claim 1, wherein the maleic acid and maleic anhydride are undetectable by reverse phase HPLC having a detection limit for maleic acid and maleic anhydride combined of 0.001% or less.

10. (canceled)

11. An article of manufacture comprising the poly(styrene-co-maleic anhydride/acid) copolymer of claim 1.

12. The article of manufacture of claim 11, for use in the field of medical bioengineering, medical devices, tissue engineering, pharmaceutical products, body hygiene, cosmetics, biotechnology, food industry, agriculture, or absorbent textiles.

13. A method of purifying a poly(styrene-co-maleic anhydride/acid) copolymer, comprising removing from the copolymer unreacted styrene monomers, unreacted maleic anhydride monomers, unreacted maleic acid monomers, low molecular weight copolymers, or a combination thereof.

14. The method of claim 13, wherein the purification comprises an acid wash, Tangential Flow Filtration, dialysis, super critical fluid extraction, or a combination thereof.

15. The method of claim 14, wherein the acid wash comprises washing the copolymer with aqueous acidic solution.

16. The method of claim 15, wherein the acidic solution comprises an acid selected from the group consisting of hydrochloric acid, hydrobromic acid, hydrofluoric acid, hydroiodic acid, nitric acid, sulfuric acid, perchloric acid, fluoroantimonic acid (HFSbF₅), magic acid (FSO₃HSbF₅), carborane superacid (CHB₁₁Cl₁₁), fluorosulphuric acid (FSO₃H), phosphoric acid, chromic acid, formic acid, acetic acid, trifluoroacetic acid, tartaric acid, citric acid, ascorbic acid; methanesulfonic acid, trifluoromethane sulfonic acid, toluenesulfonic acid, or mixtures thereof.

17. The method of claim 15, wherein the acidic solution has an acid concentration of between 0.0005-0.01 M.

18. The method of claim 15, wherein the acid is hydrochloric acid in a concentration of about 0.001 to about 0.1M.

19. (canceled)

20. The method of claim 15, wherein the aqueous acidic solution has a pH of 1.5-4.

21. (canceled)

22. The method of claim 15, wherein the acid concentration is sufficient to prevent swelling of the poly(styrene-co-maleic anhydride/acid) copolymer.

23. (canceled)

24. The method of claim 15, further comprising washing the poly(styrene-co-maleic anhydride/acid) copolymer with water.

25. The method of claim 15, wherein the temperature during the washings is less than 45° C.

26-30. (canceled)

31. The method of claim 16, further comprising filtering the poly(styrene-co-maleic anhydride/acid) copolymer.

32. (canceled)

33. The method of claim 31, comprising filtering with a filter press.

34. (canceled)

35. The method of claim 14, comprising Tangential flow filtration.

36. The method of claim 35, further comprising combining the poly(styrene-co-maleic anhydride/acid) copolymer with alkaline water.

37. The method of claim 36, wherein the pH of the alkaline water is between about 7.5 and about 10.

38. The method of claim 36, wherein the combining of the copolymer and alkaline water is performed prior to the Tangential Flow Filtration.

39. The method of claim 38, wherein the poly(styrene-co-maleic anhydride/acid) copolymer and alkaline water form a homogenous mixture.

40. The method of claim 35, wherein the Tangential Flow Filtration has a molecular weight cutoff of about 70 KD or less.

41. The method of claim 35, wherein the Tangential Flow Filtration is continued until the content of the maleic acid in the supernatant is less than 0.1% by weight.

42. (canceled)

43. The method of claim 35, wherein the temperature during the Tangential Flow Filtration is between 2° C. and 45° C.

44. The method of claim 35, further comprising maintaining the pH above 3.

45. The method of claim 35, further comprising precipitating the poly(styrene-co-maleic anhydride/acid) copolymer from the aqueous alkaline water by acidifying the mixture to a pH less than about 2.

46. The method of claim 45, wherein the mixture is acidified by adding an acid selected from the group consisting of hydrochloric acid, hydrobromic acid, hydrofluoric acid, hydroiodic acid, nitric acid, sulfuric acid, perchloric acid, fluoroantimonic acid (HFSbF₅), magic acid (FSO₃HSbF₅), carborane superacid (CHB₁₁Cl₁₁)), fluorosulphuric acid (FSO₃H), phosphoric acid, chromic acid, formic acid, acetic acid, trifluoroacetic acid, tartaric acid, citric acid, ascorbic acid; methanesulfonic acid, trifluoromethane sulfonic acid, toluenesulfonic acid, or mixtures thereof.

47. The method of claim 14, comprising dialyzing the poly(styrene-co-maleic anhydride/acid) copolymer.

48. The method of claim 47, wherein the poly(styrene-co-maleic anhydride/acid) copolymer is in an aqueous solution, wherein the solution is maintained at a pH of less than 3.

49. The method of claim 47, wherein the copolymer is in an aqueous solution, wherein the solution is maintained at a pH of greater than 6.

50. (canceled)

51. The method of claim 47, further comprising precipitating the poly(styrene-co-maleic anhydride/acid) copolymer by acidifying the aqueous solution to a pH of less than 2.

52. (canceled)

53. The method of claim 14, comprising supercritical fluid extraction.

54. The method of claim 53, wherein the supercritical fluid is supercritical carbon dioxide.

55. The method of claim 13, wherein the purifying does not comprise the use of organic solvents.
